(19) United States
(12) Patent Application Publication
(10) Pub. No.: US 2009/0038911 A1
(43) Pub. Date: Feb. 12, 2009

(54) TUBULAR BELT CONVEYOR

(75) Inventors: Satoshi Aizawa, Tokyo (JP); Kenichi Higashi, Kanagawa (JP); Takashi Yokoi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE CORPORATION, Chuo-ku, Tokyo (JP)

(21) Appl. No.: 12/067,726

(22) PCT Filed: Sep. 25, 2006
(86) PCT No.: PCT/JP2006/318907

§ 371 Date: May 20, 2008

(30) Foreign Application Priority Data
Sep. 27, 2005 (JP) 2005-279287

(51) Int. Cl. B65G 15/08; B65G 43/02

(52) U.S. Cl. 198/502.1; 198/819; 198/810.02

(57) ABSTRACT

To provide a pipe conveyer in which a twist or depression of a rounded conveyer belt is simply and efficiently detected by effectively using permanent magnets and the closability of the conveyer belt is improved. [MEANS FOR SOLVING PROBLEMS] A conveyer belt (3) is rounded into a pipe, and both side edges (3a, 3b) of the conveyer belt (3) are laid on one the other. On both opposed surfaces of the edges, permanent magnets (6, 7) attaching each other are provided. A fixed body through which the rounded conveyer belt (3) passes is provided, and a plurality of magnetic sensors (8) are so circumferentially arranged on the fixed body as to surround the conveyer belt (3) and to detect the magnetic force strengths when the permanent magnets (6, 7) pass by the fixed body. Twist detecting means (11) for comparing the detected magnetic force strengths and detecting a twist of the conveyer belt (3) from the position of the magnetic sensor (8) which has detected the peak value (P1) is provided.

### TECHNICAL FIELD

The present invention relates to a tubular belt conveyor into which an endless circulating belt is rolled up for conveying materials.

### BACKGROUND OF THE INVENTION

JP9-169423A discloses that magnetic substances are provided in each side of a trough-shaped running conveyor belt around which a fixed body includes a plurality of magnetic sensors circumferentially so that output differences from the magnetic sensors enable how the belt meanders to be detected.

However, a number of magnetic sensors are required, so that the support structure therefor becomes more complicate to increase cost.

A tubular belt conveyor into which a flat belt is rolled up dents inward by its own weight and stress, but the above publication does not disclose how to detect a depression.

### SUMMARY OF THE INVENTION

In view of the disadvantages in the prior art, it is an object of the present invention to provide a tubular belt conveyor which enables a twist and/or a depression of a rolled-up conveyor belt to be detected readily and efficiently and improves loop-closing capability of the tubular belt.

### BRIEF DESCRIPTION OF THE DRAWINGS

FIG. 1 is a perspective view of the first embodiment of the present invention.

FIG. 2 is an enlarged vertical sectional view and a block diagram of detecting means of the first embodiment of a tubular belt conveyor according to the present invention.

FIG. 3 is an enlarged vertical sectional view and a block diagram of detecting means in the second embodiment of the present invention.

FIG. 4 is an enlarged vertical sectional view and a block diagram of detecting means in the third embodiment of the present invention.

### DETAILED DESCRIPTION OF PREFERRED EMBODIMENTS

Embodiments of the invention will be described with respect to accompanying drawings.

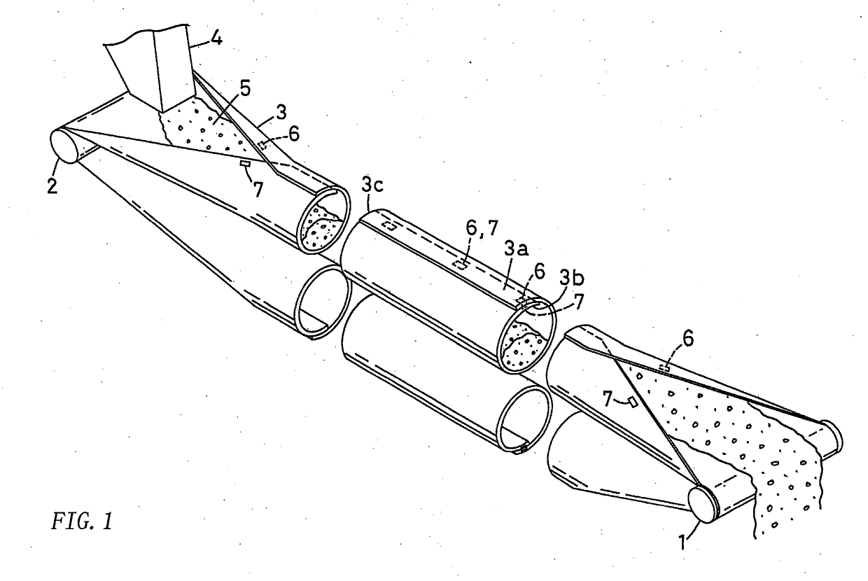

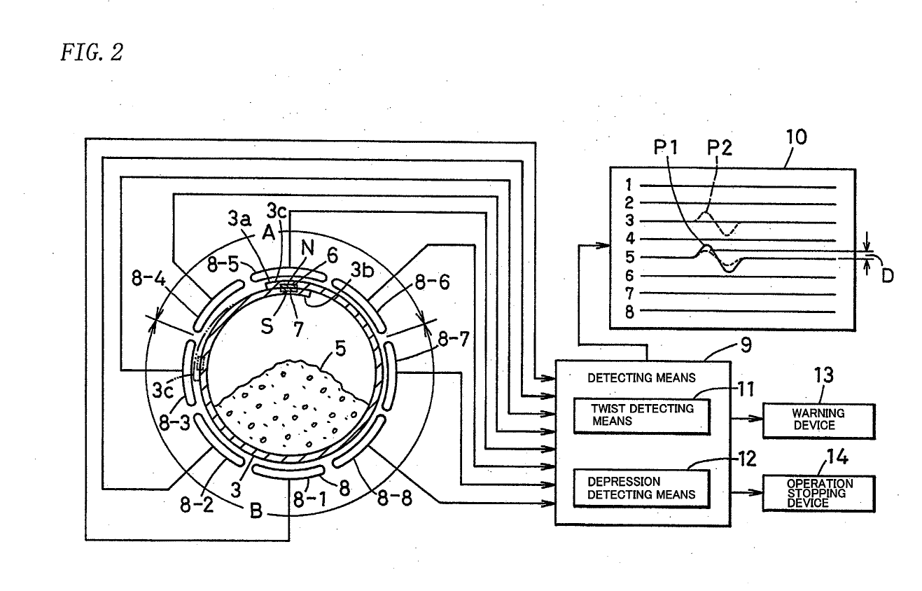

FIGS. 1 and 2 show the first embodiment of the present invention.

In FIG. 1, an endless conveyor belt 3 of a tubular belt conveyor is wound around a front pulley 1 and a rear pulley 2, and either of the front pulley 1 and the rear pulley 2 is rotated by drive means (not shown) to enable the conveyor belt 3 to circulate. An upper carrying part and a lower returning part of the conveyor belt 3 pass through a plurality of guide frames (not shown) in which a plurality of guide rollers are arranged like a ring or trough. So the conveyor belt 3 is rolled up into a tubular shape while one side edge 3a lies on the other side edge 3b, and materials 5 supplied from a hopper 4 above the rear pulley 2 is wrapped and transferred in the tubular belt.

A plurality of permanent magnets 6,7 are embedded in the conveyor belt 3 at proper intervals longitudinally of the conveyor belt 3 with opposing different magnetic poles in one side edge 3a and the other side edge 3b when the belt is rolled up in the tubular shape.

In the first embodiment, in FIG. 2, the upper and lower parts of all the permanent magnets 6 in the side edges 3a,3b of the tubular conveyor belt 3 are N- and S-poles respectively.

The magnetic poles may be reversed or may be different one by one longitudinally. Either of the permanent magnets 6,7 may be made of steel.

In FIGS. 1 and 2, the permanent magnet 6 lies on the permanent magnet 7 when the conveyor belt 3 is rolled up, but may be disposed at positions different from each other or staggered.

In FIG. 2, on a fixed body (not shown) provided at an area through which the tubular belt 3 passes, a plurality of sensors 8 for detecting magnetic strength by the passing permanent magnets 6,7 are provided circumferentially around the conveyor belt.

In the embodiment, the magnetic sensors 8 comprise eight loop coils 8-1 to 8-8. In the outer circumferential area around the tubular belt 3, there are an allowable zone A in which a twisted overlapped portion 3c in which the side edge 3a lies on the side edge 3b can run; and an unallowable zone B. There are three loop coils 8-4,8-5, 8-6 in the allowable zone A, and five loop coils 8-1,8-2, 8-3,8-7, 8-8 in the unallowable zone B.

Each of the loop coils 8-1 to 8-8 or magnetic sensor 8 is connected to detecting means 9 for finding a twist and a depression, and magnetic strength detected by the loop coils 8-1 to 8-8 is shown in a display 10 connected to the detecting means 9.

The detecting means 9 comprises twist detecting means 11 and depression detecting means 12. The twist detecting means 11 compares magnetic strength detected by the magnetic sensors 8 to identify a twist of the conveyor belt 3 depending on the magnetic sensor 8 which detects the peak.

In an untwisted state shown by solid lines in FIG. 2, the overlapped portion 3c of the conveyor belt 3 is positioned at the top, and the permanent magnets 6,7 runs close to the loop coil 8-5. In the display 10, the peak P1 is generated on the fifth line corresponding to the loop coil 8-5. The other loop coils 8-1 to 8-4 and 8-6 to 8-8 are away from the permanent magnets 6,7, and the first to fourth lines and sixth to eighth lines in the display 10 corresponding thereto are substantially straight.

By detecting with the twist detecting means 11 that the peak P1 is generated in a line detected by the loop coil 8-5, it is found that the overlapped portion 3c of the conveyor belt 3 is positioned in the range facing the loop coil 8-5, which means that the conveyor belt 3 is nearly untwisted.

If the conveyor belt 3 is twisted, for example, as shown by a dotted line, the overlapped portion 3c of the conveyor belt 3 is deviated left by 90 degrees from the solid line, the peak P2 is created in a line detected by the loop coil 8-3 facing the overlapped portion 3c, as shown in the display 10 in FIG. 2. By the detection of the twist detecting means 11, it is found that the overlapped portion 3c of the conveyor belt 3 is positioned in the range facing the loop coil 8-3, which means that the twist of the conveyor belt 3 exceeds permissible limits.

The conveyor belt 3 is twisted, so that the overlapped portion 3c is positioned in front of the loop coils 8-4 or 8-6. So the peak is created in the loop coil 8-4 or 8-6, so that it is found that the conveyor belt 3 is twisted within the permissible limits.

If the twist detecting means 11 detects that the twist of the conveyor belt 3 goes beyond the permissible limits, a warning device 13 connected to the detecting means 9 or an operation stopping device 14 for stopping the whole tubular conveyor will work.

The depression detecting means 12 identifies that the overlapped portion 3c of the conveyor belt 3 moves inward or a depression is created in a circular shape depending on an absolute value of the peak P1 detected by the magnetic sensor 8.

In the embodiment, the absolute value of the peak P1 of magnetic strength detected by the magnetic sensor 8 or an amplitude of the peak P1 in the display 10 in FIG. 2 goes down below a predetermined limit D, so that it is found that the overlapped portion 3c of conveyor belt 3 is bent inward.

The depression detecting means 12 detects a depression in the conveyor belt 3 to allow the warning device 13 and the operation stopping device 14 to be actuated to stop the whole tubular conveyor in such a manner that a twist of the conveyor belt 3 is detected by the twist detecting means 11.

According the first embodiment of the present invention, by the permanent magnets 6,7 at the side edges 3a,3b of the conveyor belt 3, a twist of the tubular conveyor belt 3 can be detected readily and efficiently. Only the permanent magnets 6,7 may be used for detection. Without a special sensor, it can be found that the overlapped portion 3c of the tubular conveyor belt 3 deviates inward which means a depression in the conveyor belt 3.

Furthermore, in the first embodiment, when the conveyor belt 3 is in a tubular shape, the permanent magnets 6,7 at the side edges 3a,3b of the conveyor belt 3 are attracted to each other to prevent the side edges 3a,3b of the conveyor belt 3 from moving away from each other, so that the conveyed materials 5 is prevented from dispersing.

The outer circumferential area of the conveyor belt 3 is divided into the allowable zone A and unallowable zone B in which the magnetic sensors 8 are provided, so that it can easily be detected that a twist of the conveyor belt 3 exceeds the permissible limits. Thus, the warning device 13 and stopping device 14 can prevent malfunction.

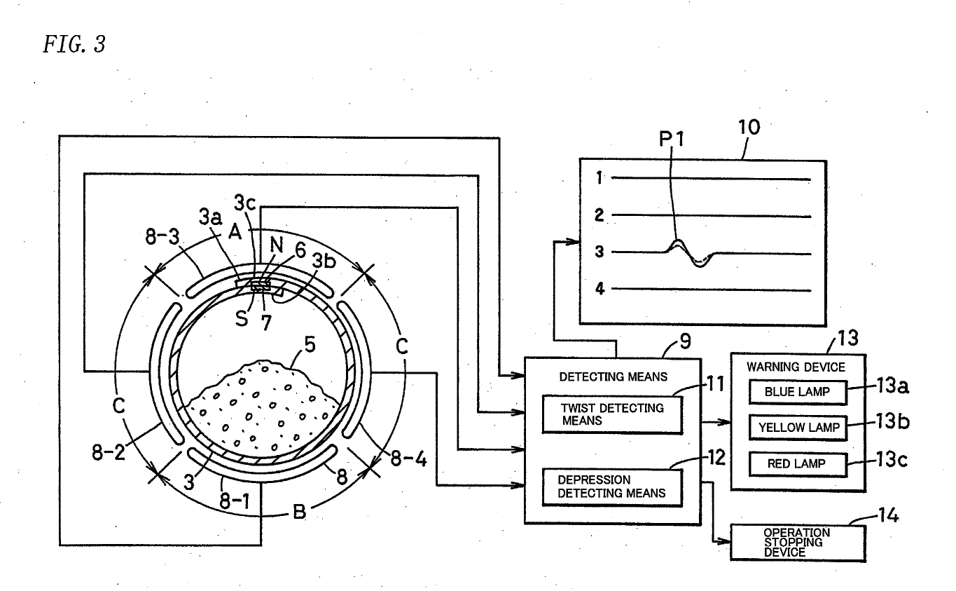

FIG. 3 shows the second embodiment of the present invention. The same numerals are allotted to the same members as those in the first embodiment, and detailed description thereon will be omitted. The same will apply to the third embodiment, which will be described later.

In this embodiment, intermediate zones C,C are provided between an allowable zone A and an unallowable zone B. Magnetic sensors 8 such as loop coils 8-1,8-2, 8-3,8-4 are provided in order of the unallowable zone B, intermediate zone C, allowable zone A and intermediate zone C. If the loop coil 8-2 or 8-4 of the intermediate zones C detects the peak of magnetic strength, twist detecting means 11 will identify a twist of the conveyor belt 3 under a caution.

In the embodiment, a warning device 13 comprises a blue lamp 13a, a yellow lamp 13b and a red lamp 13c. The blue lamp 13a will turn on if a twist of the conveyor belt 3 is identified to be within an allowable zone, the yellow lamp 13b will turn on and off if a twist of the conveyor belt 3 is identified to be cautious, and the red lamp 13c will turn on and off if a twist of the conveyor belt 3 is identified to be dangerous beyond the permissible limits.

A twist of the conveyor belt 3 can be detected more precisely and in more detail than what comprises only allowable zone and allowable zones.

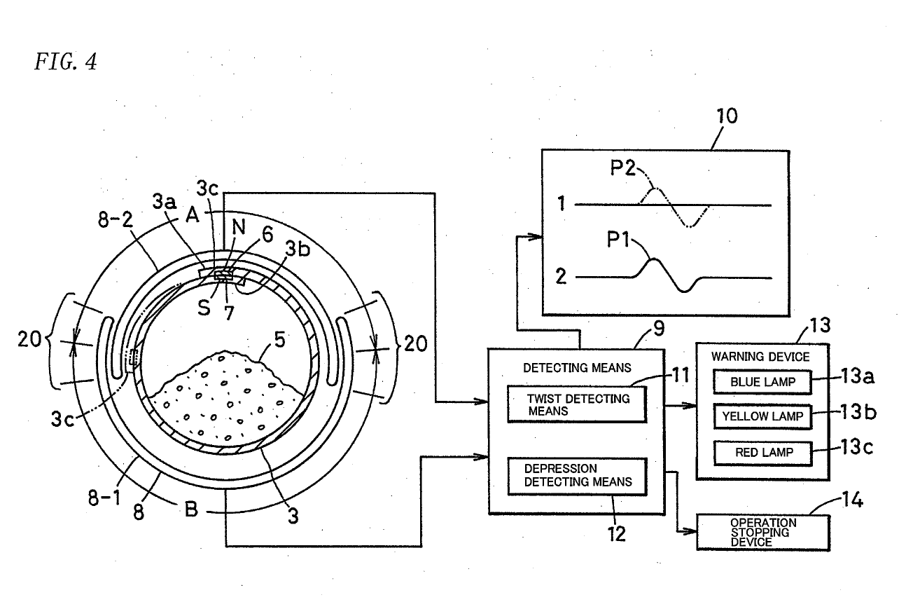

FIG. 4 shows the fourth embodiment of the present invention.

The outer circumferential area around a tubular conveyor belt 3 is divided into two zones of an allowable zone A and an unallowable zone B, each of which comprises a magnetic sensor 8 such as loop coils 8-1 or 8-2 respectively. Between the zones A and B, one circumferential edge of the magnetic sensors 8 lies on the other circumferential edge to form an overlapped portions 20. If permanent magnets 6,7 faces the overlapped portion 20 of the magnetic sensor 8, the magnetic sensors 8,8 will detect the substantially equal-magnitude peaks P1,P2 as shown in a display 10 of FIG. 4 to allow twist detecting means 11 to identify a cautious position where an overlapped portion 3c of the conveyor belt 3 is placed in a boarder of the zones A,B.

By the only two magnetic sensors 8, the twist of the conveyor belt 3 can be detected exactly in detail similar to the second embodiment comprising the four magnetic sensors 8.

In the second embodiment, between the adjacent zones A-B, B-C, C-D, D-A, an overlapped portion of the magnetic sensors 8 face the permanent magnets 6,7 of the conveyor belt 3. The adjacent magnetic sensors 8,8 detects substantially the same magnitude peaks to identify that the overlapped portion 3c of the conveyor belt 3 is placed at a boarder of the adjacent zones to enable a twist of the conveyor belt 3 to be detected exactly in more detail.

The foregoing relates to three embodiments of the present invention and is only for illustration only. Various changes and modifications may be made without departing from the scope of claims.

For example, either of the twist detecting means 11 and depression detecting means 12 may be omitted.

The magnetic sensor 8 may be a hall element, a gaussmeter or an MI sensor instead of the loop coil.

The permanent magnet may be a sintered magnet or a magnet sheet.

The sintered magnet is suitable for more precise detection, and a rubber magnet sheet is suitable for adherence and durability.

1-8. (canceled)

9. A tubular belt conveyor comprising:
an endless flat belt that is rolled up into a tubular belt by forming an overlapped portion in which a first side edge lies on a second side edge, materials being conveyed in the tubular belt, a permanent magnet being provided in either of the first side edge and the second side edge;
a fixed body through which the tubular belt passes, said fixed body having a plurality of magnetic sensors arranged circumferentially around the tubular belt to detect magnetic strength of the permanent magnet in the belt when the tubular belt passes through the fixed body, said plurality of magnetic sensors being placed in two zones of an allowable zone and an unallowable zone; and
twist detecting means connected to each of said plurality of magnetic sensors to compare magnetic strengths detected by the magnetic sensors to find that a twist of the tubular belt exceeds permissible limits by magnetic strength detected by the magnetic sensor in the unallowable zone.

10. A tubular belt conveyor of claim 9, further comprising a display connected to the twist detecting means to display magnetic strength of each of said plurality of magnetic sensors, a peak appearing on a line detected by the magnetic sensors in the unallowable zone to find that the twist exceeds the permissible limits.

11. A tubular belt conveyor of claim 9, further comprising a warning device connected to the twist detecting means to warn when the twist exceeds the permissible limits.

12. A tubular belt conveyor of claim 10, further comprising an operation stopping device connected to the twist detecting means to stop the tubular belt conveyor if the twist exceeds the permissible limits.

13. A tubular belt conveyor of claim 10 wherein an intermediate zone is provided between the allowable zone and the unallowable zone, the peak appearing on a value detected by the magnetic sensor in the intermediate zone to show that the twist of the conveyor belt becomes cautious.

14. A tubular belt conveyor of claim 10 wherein said twist detecting means also detects that the overlapped portion of the tubular belt deviates inward based on an absolute value of the peak in the display.

15. A tubular belt conveyor of claim 10 wherein a magnetic sensor is provided in an intermediate zone between the allowable zone and the unallowable zone, the peak appearing in the display on a line corresponding to the magnetic sensor in the intermediate zone to show that the twist of the conveyor belt is cautious.

16. A tubular belt conveyor of claim 10 wherein an overlapped portion of the magnetic sensors is provided between the allowable zone and the unallowable zone thereby showing that the twist of the conveyor belt is cautious.

17. A tubular conveyor belt of claim 9 wherein each of said plurality of magnetic sensors comprises a loop coil.

18. A tubular conveyor belt of claim 11 wherein the warning device includes a plurality of lamps emitting different colors depending on how to twist the conveyor belt.

19. A tubular belt conveyor comprising:
an endless flat belt that is rolled up into a tubular belt by forming an overlapped portion in which a first side edge lies on a second side edge, materials being conveyed in the tubular belt, a permanent magnet being provided in either of the first side edge and the second side edge;
a fixed body through which the tubular belt passes, said fixed body having a plurality of magnetic sensors arranged circumferentially around the tubular belt to detect magnetic strength of the permanent magnet in the belt when the tubular belt passes through the fixed body, said plurality of magnetic sensors being placed in two zones of an allowable zone and an unallowable zone; and
depression detecting means connected to each of said plurality of magnetic sensors, detecting that the overlapped portion of said conveyor belt deviates inward based on an absolute value of the magnetic strength.
